(19) United States
(12) Patent Application Publication
(10) Pub. No.: US 2023/0047153 A1
(43) Pub. Date: Feb. 16, 2023

(54) FACE MASK

(71) Applicants: Min Yao, Irvine, CA (US); Roy Yao, Irvine, CA (US)

(72) Inventors: Min Yao, Irvine, CA (US); Roy Yao, Irvine, CA (US)

(21) Appl. No.: 17/540,977

(22) Filed: Dec. 2, 2021

Related U.S. Application Data
(60) Provisional application No. 63/233,463, filed on Aug. 16, 2021.

(51) Int. Cl. A41D 13/11

(52) U.S. Cl. CPC A41D 13/1192; A41D 13/1161

(57) ABSTRACT

Face mask including a mask body, lining around an edge of the mask body, and a nose strip, wherein the complete face mask including the mask body, the lining, and the nose strip is made of a single recyclable material, such as PET. The face mask can be ground directly for recycling without first separating the parts of the face mask.

### CROSS-REFERENCE TO RELATED APPLICATIONS

This application claims priority from the U.S. provisional patent application Ser. No. 63/233,463 filed on Aug. 16, 2021, which is incorporated herein by reference in its entirety.

### FIELD OF INVENTION

The present invention relates to a recyclable face mask, and more particularly, the present invention relates to a face mask made from a single material.

### BACKGROUND

Breath is essential for life. However, millions of germs and pollutants can be suspended in the air that is breathed. Pathogenic germs, such as Viruses can make their way into the body with the air through the nose. Pollutants in the air cause allergies in many people.

Face masks made from a porous material that could at least cover the nose are used that filter the air and the filtered air is inhaled. Depending upon the pore size of the face mask, particles of different sizes can be filtered by the face mask.

A typical face mask has a mask body, ear straps, and a nose strip. The mask body consists of three layers of cloth, of which the outer and inner layers of the mask body are made of non-woven polypropylene fabric and the middle layer is made of melt-blown cloth. The outermost layer of the mask has an anti-droplet design, the middle layer is the core functional layer for filtering droplets, particles, or bacteria, and the inner layer mainly absorbs moisture; the ear straps are made of nylon and spandex, and the nose strip is made of metal.

Face masks are commercially available as disposable and reusable. The disposable face masks are economical but can be used only once. Moreover, the common disposable masks are made of a combination of materials, which are difficult to separate for recycling. The recycling cost is also high for disposable masks leading to landfills and environmental pollution. It is estimated that about 3,500^{˜}4,000 tons of discarded masks are produced in China alone every day. Environmental experts say that it takes at least 450 years for a disposable mask to degrade because it contains materials that are difficult to decompose and cannot be mixed with recycled waste in the same trash. Reusable face mask can be used a few numbers of times, however, recycling of reusable face masks also presents the same problems.

A need is appreciated for a novel face mask that can be recycled easily and cost-effectively.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a recyclable face mask that covers at least the nose and mouth of a wearer.

It is another object of the present invention that the face mask is made of a single material.

It is another object of the present invention that the face mask can be transparent.

It is still another object of the present invention that the face mask can be quickly and easily recycled.

It is yet another object of the present invention that the face mask is economical to manufacture and recycle.

It is a further object of the present invention that the face mask has excellent air-filtering properties.

It is still a further object of the present invention that the face mask is comfortable to the skin.

It is yet a further object of the present invention that the face mask can be reused multiple times.

It is an additional object of the present invention that the face mask does not hide lips while communicating.

It is still another object of the present invention that the face mask does not hide facial expressions, such as a smile.

In one aspect, disclosed is a face mask having a mask body, one or more straps extending from the mask body that can secure the face mask to the head of the wearer, and a nose strip. The mask body can at least cover the nose of the wearer. The mask body can optionally have a lining of the same material as the mask body. The nose strip can fit over the nose bridge.

In one aspect, the mask body, one or more straps, and the nose strip can be made from recyclable single material.

In one aspect, the single material can be polyethylene terephthalate (PET).

In one aspect, at least the mask body of the face mask is porous fabric or porous film made of polyethylene terephthalate. The film can be transparent.

In one aspect, the disclosed face mask can be treated with an antimicrobial solution that prevents the growth of microbes on the surface or in the pores of the mask body.

In one aspect, the mask body implemented as a PET film can be treated to have anti-fog and anti-scratch properties.

In one aspect, the mask body, the lining, and the straps can be made from PET.

In one aspect, the straps can be provided with slide adjusters to adjust the length of the straps. The slide adjusters are made of PET material.

In one aspect, the mask body and lining can be made thin and transparent virtually making the mask invisible.

In one aspect, the pore size of the mask body can be controlled for filtering out viruses, bacteria, dust particles, smoke particles, and other particulate air pollutants.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a side view of the face mask showing the mask body, lining around the mask body, straps, and a nose strip, according to an exemplary embodiment of the present invention.

FIG. 2 is a front view of the face mask shown in FIG. 1, according to an exemplary embodiment of the present invention.

FIG. 3 shows the slide adjuster, according to an exemplary embodiment of the present invention.

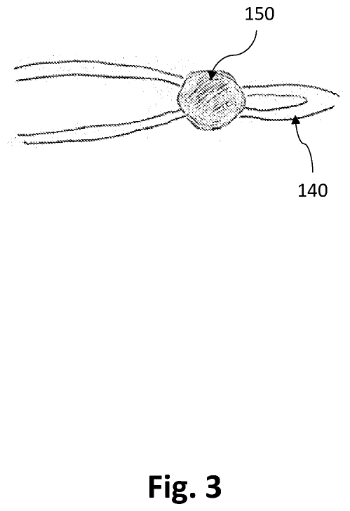

### DETAILED DESCRIPTION

The accompanying figures, which are incorporated herein, form part of the specification and illustrate embodiments of the present invention. Together with the description, the figures further explain the principles of the present invention and to enable a person skilled in the relevant arts to make and use the invention.

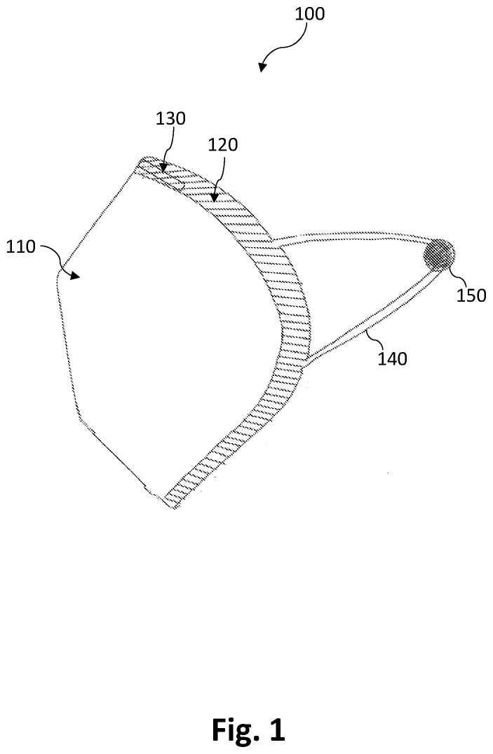

Disclosed is a face mask made from a single material, such as PET that makes recycling of the face mask faster and cost-effective. Referring to FIG. 1, which shows an exemplary embodiment of the face mask 100. The face mask 100 can include a mask body 100 that can at least cover the nose and mouth of the wearer. The mask body can be made from a porous material through which air can be filtered and the filtered air can be breathed. Preferably, the mask body can be made from polyethylene terephthalate. The mask body can be made from porous fabric or porous film of polyethylene terephthalate. In case, the film is used, the mask body can be made transparent. The transparent mask body, by not hiding the face, allows expressing the facial expressions and allows better communication between persons. The porosity of the transparent film made of polyethylene terephthalate and used to manufacture the mask body can efficiently filter pollutants and germs. The porous fabric made from polyethylene terephthalate can also be used to manufacture the mask body.

Surrounding the mask body 110 can be seen as a lining 120 that can stitch or bond to cover the edges of the mask body 110. The lining can provide a smooth finish and can increase the life of the face mask. The lining, however, can be optional. When present, the lining can be made of the same material as the mask body. The lining can preferably be made of polyethylene terephthalate. For example, the lining can be made from fabric polyethylene terephthalate. The lining can have an additional function to closely fit against the skin of the face to prevent ingress of unfiltered air. The lining can be treated with a disinfectant. Perhaps, the disclosed face mask can be cleaned and disinfected for reuse. When the mask body is made from PET film, the same can be treated for additional functionalities, such as anti-fog and anti-scratch features can be added. The fibers of PET used in the manufacture of mask body or lining can be treated with antimicrobials to prevent the growth of microbes on the surface or within the pores. The lining and the mask body can also be subjected to thermal regulating technology to improve comfort during wearing.

The disclosed face mask can also include a nose strip 130 made of the same material as the mask body and the lining. Preferably, the nose strip can be made of polyethylene terephthalate. The functioning of nose strips in the face masks is known to a skilled person for securing the face mask around the nose bridge. The nose bridge can be embedded in the lining.

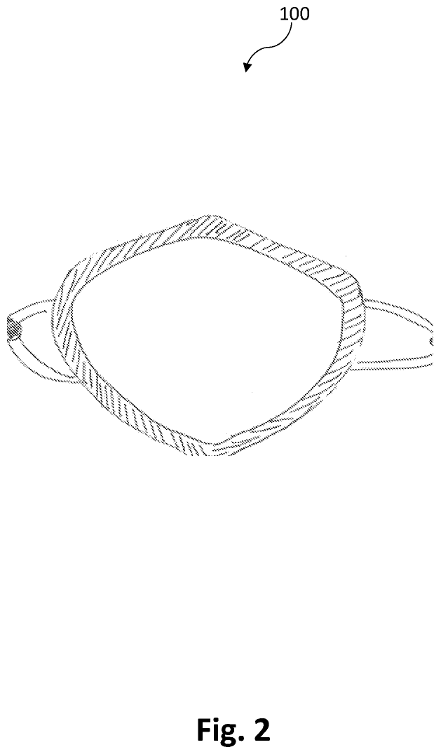

The disclosed face mask can also include straps 140 that can extend from the mask body or the lining and can be used to secure the face mask to the head of the wearer. FIGS. 1 and 2 show the straps as ear loops. The straps 140 can be made of the same material as used for the mask body and lining. Preferably, the straps can be made of polyethylene terephthalate.

FIG. 1 also shows a slide adjuster 150 mounted to the straps 140. The slide adjuster can be used to increase or decrease the effective length of the strap, ear loop in FIG. 1. The slide adjuster can also be made of the same material as used for mask body and lining. Preferably, the slide adjuster can be made of polyethylene terephthalate

In a preferred embodiment, the PET filter core material can be filled at the edge of the mask body, so that viruses, dust, bacteria, and other particles can be shielded, thus protecting the wearer's health. The nose strip can be ergonomically designed to fit the contours of the nose bridge without the use of metal wire. The nose strip can be thickened so that to retain shape and prevent the ingress of unfiltered air from the gaps. The mask body can also be implemented such that it can conform to the contours of the face.

In one aspect, the disclosed face mask can be disposed of separately from other garbage and with other PET waste for recycling. The disposed of face mask can be directly subjected to grinding and granulation to form PET flakes without first disintegrating the face mask. It is understood that the recycling of PET waste may involve other steps.

The above mentioned is only a preferred embodiment of the invention, not any formal limitation of the invention, although the invention has been disclosed as above with better embodiments, however, not to limit the invention, any skilled person familiar with the profession, within the scope of the technical solution of the invention, when using the above revealed technical content to make some changes or modification for equivalent changes to the equivalent embodiment. However, any simple modifications, equivalent changes and modifications made to the above embodiments according to the technical substance of the present invention, without departing from the content of the technical solution of the present invention, still fall within the scope of the technical solution of the present invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A face mask comprising:
a mask body configured to cover at least a nose and a mouth of a wearer, the mask body made of polyethylene terephthalate; and
one or more straps configured to secure the mask body to a head of the wearer, wherein the one or more straps are made of polyethylene terephthalate.

2. The face mask according to claim 1, wherein the face mask further comprises a lining surrounding an edge of the mask body, the lining is made of polyethylene terephthalate.

3. The face mask according to claim 2, wherein the face mask further comprises a nose strip configured to fit over a nose bridge of the wearer, the nose strip is made of polyethylene terephthalate.

4. The face mask according to claim 3, wherein the face mask further comprises one or more slide adjusters operably mounted to the one or more straps, the one or more slide adjusters made of polyethylene terephthalate.

5. The face mask according to claim 1, wherein the mask body is made of porous and transparent polyethylene terephthalate film.

6. The face mask according to claim 1, wherein the mask body is made from porous polyethylene terephthalate fabric.

7. The face mask according to claim 2, wherein the lining is made of polyethylene terephthalate fabric.

8. The face mask according to claim 7, wherein the lining has an antimicrobial coating.
